(19) United States
(12) Patent Application Publication
(10) Pub. No.: US 2018/0220805 A1
(43) Pub. Date: Aug. 9, 2018

(54) VIBRATION MOTOR ASSEMBLY FOR BED FACILITY

(71) Applicant: ASCION, LLC D/B/A REVERIE, Bloomfield Hills, MI (US)

(72) Inventors: Martin B. Rawls-Meehan, Birmingham, MI (US); Kushan Gajjar, Bloomfield Hills, MI (US); Qianyu Liang, Auburn Hills, MI (US)

(21) Appl. No.: 15/891,511

(22) Filed: Feb. 8, 2018

Related U.S. Application Data
(60) Provisional application No. 62/456,204, filed on Feb. 8, 2017.

(51) Int. Cl. A47C 21/00; A61G 7/018

(52) U.S. Cl. CPC A47C 21/006; A61G 7/018

(57) ABSTRACT

The disclosure generally relates to a vibration motor assembly. The vibration motor assembly includes a vibration motor, at least one flexible connector adapted to suspend the vibration motor from a bed frame support surface, and a controller adapted to control the vibration motor. The vibration motor assembly further includes an attachment means for attaching the flexible connector to the bed frame support surface and/or an attachment means for attaching the controller to the bed frame support surface or a corresponding bed facility. The vibration motor assembly can be provided in the form of a kit including the vibration motor, the flexible connector(s), the controller, and optionally a remote control and/or further mounting elements for attaching the flexible connector(s) and/or the controller to a bed frame support surface, such as part of an adjustable bed facility or a fixed bed facility which can further include a mattress supported thereon.

### CROSS REFERENCE TO RELATED APPLICATION

Priority is claimed to U.S. Provisional Application No. 62/456,204 filed Feb. 8, 2017, which is incorporated herein by reference in its entirety.

### BACKGROUND OF THE DISCLOSURE

The disclosure generally relates to a vibration motor assembly for a bed facility, for example a bed facility with an adjustable bed frame or a fixed bed frame.

Adjustable furniture, including chairs, couches, beds, and other furniture, may contain at least one section of component of which a user may control a feature or attribute, such as the position, vibration, motion, or the like of that section or component. The user may typically adjust the bed by using a control, which may be an on-furniture controller or a remote controller, to move an adjustable section in one or more directions of movement. Additionally, the adjustable furniture may include various types of mattresses, cushions, pillows, or similar elements to cushion the furniture for the user, and the furniture may allow for vibration, heating, cooling, or other action related to one or more of the sections.

A typical adjustable bed may consist of a wood decking for each of the sections of the bed connected together with hinges to allow the various positions between the sections. There are actuators connected between the bed frame and the wood decking for moving the adjustable sections into user-desired positions. The adjustable bed may have a “wall hugging” feature that maintains a consistent distance between the mattress and the wall as the bed is adjusted. Some adjustable beds may use wooden or plastic slats to support the mattress instead of a solid wood platform.

The adjustable bed may have at least one actuator to position the adjustable bed sections. In some cases, there is one actuator to position more than one, such as positioning both the thigh and foot sections with one actuator. There may also be more than one actuator for each adjustable section.

Hospitals have used adjustable beds for many years to provide comfortable and medically required positions, and many home users have adjustable furniture because of a medical issue and therefore require certain positions, movements, or settings (such as vibration, heating, cooling or the like) to aid recovery, positioning to relieve discomfort as a result of pain, or the like. These users, whether at home or in a medical environment such as a hospital, nursing home, assisted living facility, or long-term care facility, may, because of these issues, spend significant amounts of time in bed, and some users may be confined to spending long periods of time in or on furniture. With aging populations in many countries, such as the United States, more and more users face such confinement.

Associated with the trend for users to spend more time in sedentary positions, such as in bed, is a trend toward increasing use of technology in home and medical environments, including in rooms where users have adjustable furniture. Such technology includes increasingly sophisticated computer and networking technology, entertainment technology, information technology, and the like. While many existing adjustable beds provide the basic requirements of moving sections to positions that are required by a user, a need exists for adjustable furniture that works in better association with other technologies that are capable of being deployed in the environments in which the furniture is used.

### SUMMARY

In one aspect, the disclosure relates to a vibration motor assembly comprising: a vibration motor; at least one flexible connector adapted to suspend the vibration motor from a bed frame support surface; a controller adapted to control the vibration motor; and at least one of (i) an attachment means for attaching the flexible connector to the bed frame support surface and (ii) an attachment means for attaching the controller to the bed frame support surface or a corresponding bed facility. The attachment means for attaching the flexible connector can be selected from the group consisting of a hook element, a screw or bolt element, a flexible plastic tie element, a hook-and-loop fastening element, a bracket element, and combinations thereof. The attachment means for attaching the controller can be selected from the group consisting of a hook element, a screw or bolt element, a flexible plastic tie element, a hook-and-loop fastening element, a bracket element, and combinations thereof.

In another aspect, the disclosure relates to a bed facility comprising: a bed frame support surface; and a vibration motor assembly according to any of the various embodiments, wherein the vibration motor is suspended from the bed frame support surface by the at least one flexible connector, and the controller is associated with the bed frame support surface or other component of the bed facility (e.g., attached or mounted thereto). The bed frame support surface can be an adjustable bed frame comprising at least one articulating section; and the bed facility can further comprise an actuator associated with the adjustable bed frame and adapted to move the at least one articulating section. The bed frame support surface can be a fixed bed frame.

### BRIEF DESCRIPTION OF THE DRAWINGS

For a more complete understanding of the disclosure, reference should be made to the following detailed description and accompanying drawings wherein:

FIG. 1A illustrates a top view of a vibration motor according to the disclosure including flexible ropes and corresponding hook connectors for attachment to a bed frame support surface. Also illustrated is a wired electrical connection to a vibration motor controller (not shown) which can be mounted to the bed facility.

FIG. 1B illustrates an end view of a vibration motor according to the disclosure and including an opening through which the flexible connector passes to provide removable attachment to the vibration motor.

FIG. 1C illustrates a top view of a vibration motor according to the disclosure including flexible ropes and corresponding plastic tie connectors for attachment to a bed frame support surface.

FIG. 2 illustrates a perspective view a controller adapted to control the vibration motor along with associated mounting brackets for attachment of the controller to a bed frame support surface or other component of a bed facility.

FIG. 3A illustrates a side view of a vibration motor according to the disclosure mounted within an opening of a bed facility lateral surface.

FIG. 3B illustrates a flexible connector according to the disclosure for attachment/suspension of the vibration motor to a bed support surface.

FIG. 3C illustrates a vibration motor according to the disclosure with a flexible connector passing through an opening on the vibration motor for removable attachment to the vibration motor.

FIG. 3D illustrates a vibration motor according to the disclosure mounted on a lateral surface with flexible connectors and a housing.

FIG. 4A shows a block diagram of an adjustable bed facility and associated components.

FIG. 4B shows a block diagram of an adjustable bed facility and associated components.

### DETAILED DESCRIPTION

The disclosure generally relates to a vibration motor assembly comprising: a vibration motor; at least one flexible connector adapted to suspend the vibration motor from a bed frame support surface; and a controller adapted to control the vibration motor. The vibration motor assembly can be provided in the form of a kit including the vibration motor, the flexible connector(s), the controller, and optionally a remote control and/or further mounting elements for attaching the flexible connector(s) and/or the controller to a bed frame support surface (e.g., as part of an adjustable bed facility or a fixed bed facility which can further include a mattress supported thereon).

The vibration motor assembly can be a component of a bed facility (e.g., adjustable or fixed bed facility) including an adjustable or a fixed bed frame defining a support surface (e.g., for supporting a mattress thereon). The bed frame can include a plurality of lateral and longitudinal support elements (e.g., metal frame supports) that generally define a plurality of openings (e.g., rectangular openings in a skeleton-type structure), one or more of which may be used to suspend the vibration motor via the flexible connector(s), which can be mounted or otherwise attached to the bed frame (e.g., to one or more lateral or longitudinal support elements thereof and defining an opening). The controller can be associated with or otherwise attached to the bed frame (e.g., to one or more lateral and/or longitudinal support elements thereof) or other components of a bed mechanical layer. In embodiments with an adjustable bed frame, the adjustable bed frame includes at least one articulating section (e.g., 1, 2, or 3 articulating sections for any of the back/head section, leg section, and/or foot section) and at least one actuator associated with or otherwise attached to the bed frame (e.g., to one or more lateral and/or longitudinal support elements thereof) or other components of a bed mechanical layer. The at least one actuator is adapted to move or articulate (e.g., rotate around a pivot axis) the at least one articulating section.

Various refinements and embodiments of the vibration motor assembly (or corresponding kit) are possible.

In a refinement, the controller is adapted to control one or more of vibration frequency and vibration intensity of the vibration motor.

In another refinement, the controller is adapted to wirelessly receive a command from a remote control for control of the vibration motor.

In another refinement, the flexible connector is removably attachable to the vibration motor. In a further refinement, the vibration motor comprises at least one opening through which the flexible connector is adapted to pass to suspend the vibration motor. In an alternative refinement, the flexible connector is permanently attached to the vibration motor.

In another refinement, the flexible connector comprises a flexible rope.

In another refinement, the vibration motor assembly comprises at least two flexible connectors adapted to suspend the vibration motor.

In another refinement, the flexible connector is adapted to dampen vibration of the vibration motor

In another refinement, the vibration motor assembly further comprises a housing adapted to mount to the bed frame support surface and at least partially enclose the vibration motor and the flexible connector.

In another refinement, the flexible connector comprises a loop connector adapted to attach the flexible connector to the bed frame support surface.

In another refinement, the flexible connector comprises a hook connector adapted to attach the flexible connector to the bed frame support surface.

In another refinement, the vibration motor assembly further comprises an attachment means for attaching the flexible connector to the bed frame support surface. In a further refinement, the attachment means for attaching the flexible connector is selected from the group consisting of a hook element, a screw or bolt element, a flexible plastic tie element, a hook-and-loop fastening element, a bracket element, and combinations thereof.

In another refinement, the vibration motor assembly further comprises an attachment means for attaching the controller to the bed frame support surface. In a further refinement, the attachment means for attaching the controller is selected from the group consisting of a hook element, a screw or bolt element, a flexible plastic tie element, a hook-and-loop fastening element, a bracket element, and combinations thereof.

In another refinement, the vibration motor assembly further comprises a remote control adapted to transmit a command to the controller for control of the vibration motor via a wired or wireless communication link to the controller.

In an aspect, the disclosure further relates to a bed facility comprising: a bed frame support surface; and a vibration motor assembly according to any of the various embodiments, wherein the vibration motor is suspended from the bed frame support surface by the at least one flexible connector, and the controller is associated with the bed frame support surface or other component of the bed facility (e.g., attached or mounted thereto).

In a refinement, the bed frame support surface comprises a plurality of lateral support elements and longitudinal support elements defining a plurality of openings; and the at least one flexible connector is attached to at least one of the lateral support elements and the longitudinal support elements to suspend the vibration motor from the bed frame support.

In another refinement, the bed frame support surface is an adjustable bed frame comprising at least one articulating section; and the bed facility further comprises an actuator associated with the adjustable bed frame and adapted to move the at least one articulating section.

In another refinement, the bed frame support surface is a fixed bed frame.

In the following description, terms such as “adjustable mattress,” “adjustable bed,” “adjustable bed facility” and the like are used interchangeably to refer generally to an apparatus or bed facility including a sleeping or resting surface with one or more adjustable or moveable sub-surfaces that can be positioned for user comfort and/or convenience, unless a specific meaning is explicitly provided or otherwise clear from the context. Although aspects of the disclosure may be described as relating to an adjustable bed, it is understood that the same aspects may be applied to other rest facilities that may include a bed, a couch, a chair, or the like. Such rest facilities may be in a home, a car, a recreational vehicle, a cruise ship, an airline, a train, or anywhere that a user required them, and they may be fixed or mobile.

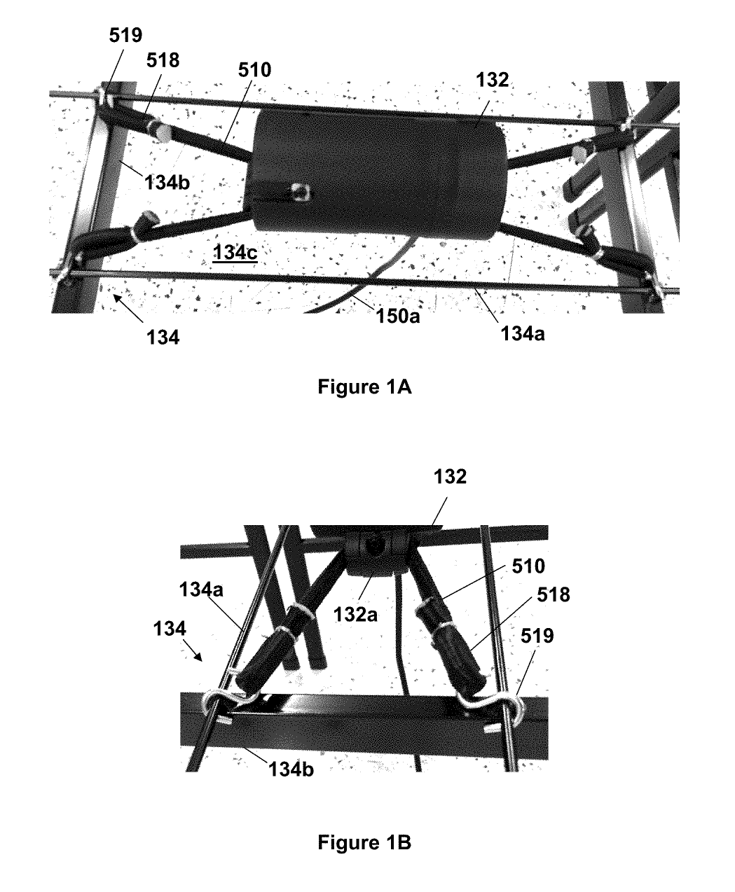

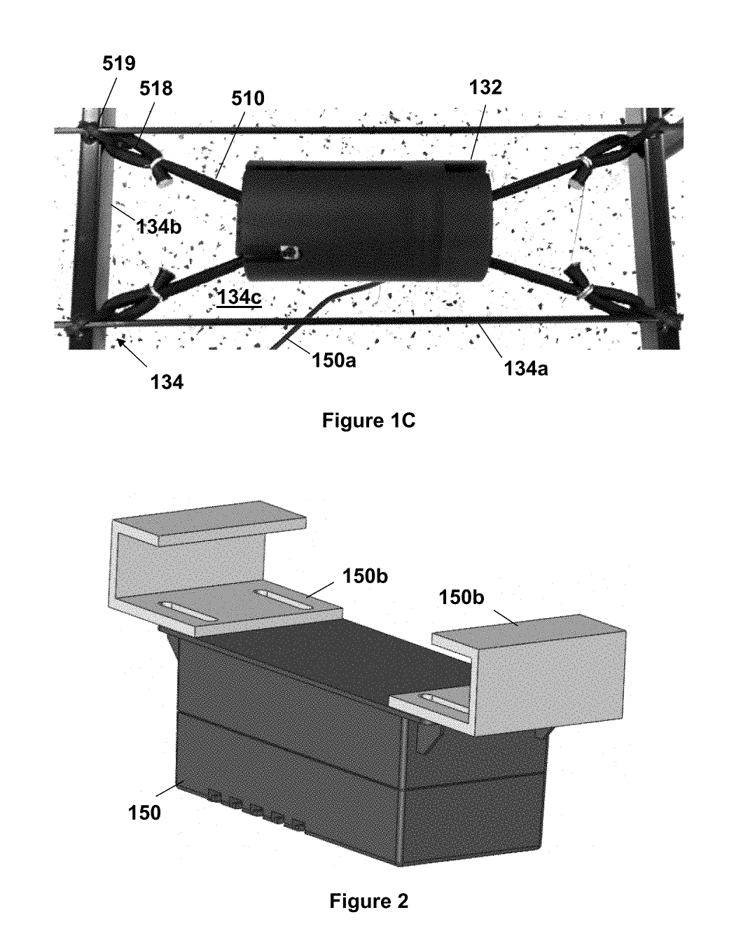

FIGS. 1A-1C illustrate a vibration motor, flexible connectors, and bed facility/bed frame support structure according to the disclosure.

FIG. 1A illustrates a top view of a vibration motor 132 according to the disclosure including flexible ropes as flexible connectors 510 and corresponding hook connectors as attachment means 519 for attachment to a bed frame support surface 134. As illustrated, opposing longitudinal ends of the flexible connectors 510 can include loop connectors 518 or other attachment means to attach the flexible connectors 510 to the bed frame support 134 (e.g., via the hook connectors or other attachment means 519 attached to the loop connectors 518 and the bed frame support 134). The bed frame support 134 includes lateral support elements 134a and longitudinal support elements 134b that generally define a plurality of openings 134c from which the vibration motor 132 can be suspended via the flexible connector 510. Also illustrated is a wired electrical connection 150a to a vibration motor controller 150 (FIG. 2) which can be mounted to the bed facility, for example to the bed frame support 134 (e.g., to the same or different support element as the vibration motor 132).

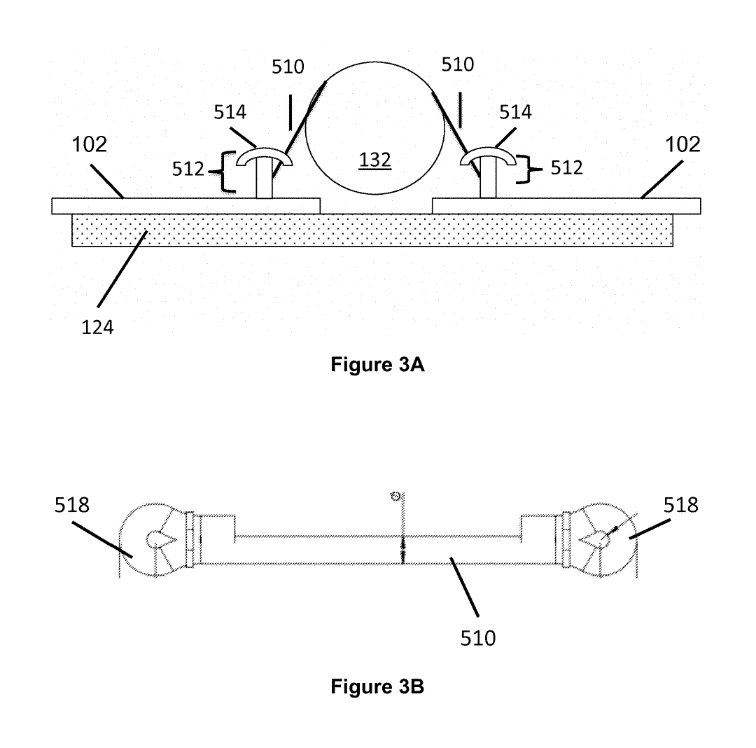

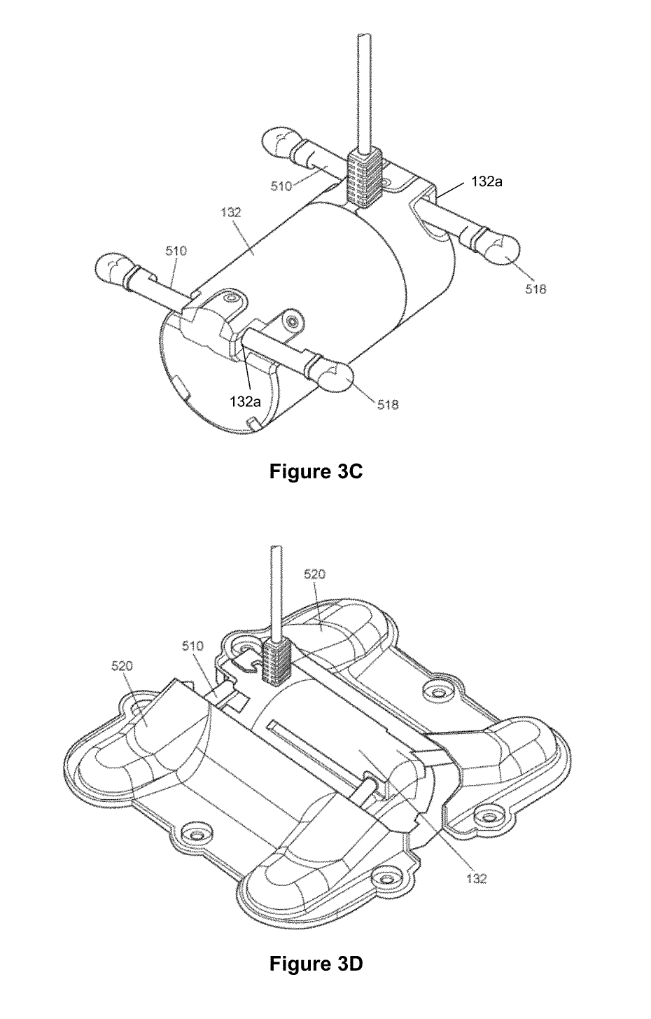

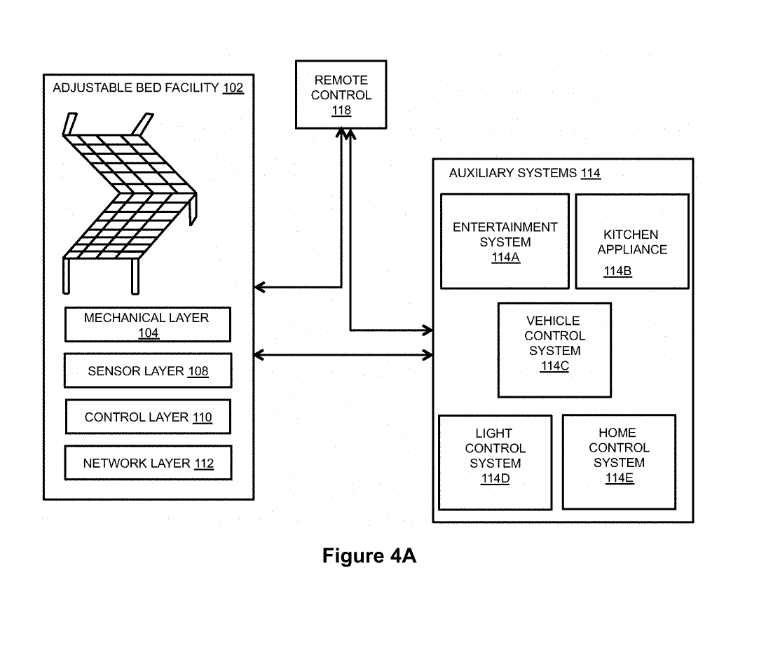

FIG. 1B illustrates an end view of the vibration motor 132 according to the disclosure. The vibration motor 132 includes one or more opening 132a through which the flexible connector 510 passes to removable attachment of the flexible connector 510 to the vibration motor 132. Suitably, the vibration motor 132 includes at least two openings 132a positioned at opposing sides or ends of the vibration motor 132 (FIG. 3C).

FIG. 1C illustrates a top view of a vibration motor 132 according to the disclosure including flexible ropes as flexible connectors 510 and corresponding plastic tie connectors as attachment means 519 for attachment to a bed frame support surface 134. More generally, the attachment means 519 can include one or more of a hook element (FIG. 1A), a screw or bolt element, a flexible plastic tie element (FIG. 1C), a hook-and-loop fastening element, a bracket element, and combinations thereof. Other illustrated structures are the same as in FIG. 1A.

FIG. 2 illustrates a perspective view a controller 150 adapted to control the vibration motor 132 along with associated mounting brackets as attachment means 150b for attachment to a bed frame support surface 134 other component of a bed facility. More generally, the attachment means 150b can include one or more of a hook element, a screw or bolt element, a flexible plastic tie element, a hook-and-loop fastening element, a bracket element (as illustrated), and combinations thereof. The vibration motor controller 150 can be mounted to the bed facility, for example to the bed frame support 134 (e.g., to the same or different support element as the vibration motor 132).

FIGS. 3A-3D illustrate a vibration motor and components thereof according to the disclosure. FIG. 3A illustrates a side view of the vibration motor 132 mounted within an opening of a bed facility lateral surface. FIG. 3B illustrates the flexible connector 510 including attachment means 518 according to the disclosure for attachment/suspension of the vibration motor 132 to a bed support surface 134. FIG. 3C illustrates the vibration motor 132 according to the disclosure with the flexible connector 510 passing through the opening 132a on the vibration motor 132 for removable attachment to the vibration motor 132. FIG. 3D illustrates the vibration motor 132 according to the disclosure mounted on a lateral surface with the flexible connectors 510 and a housing 520.

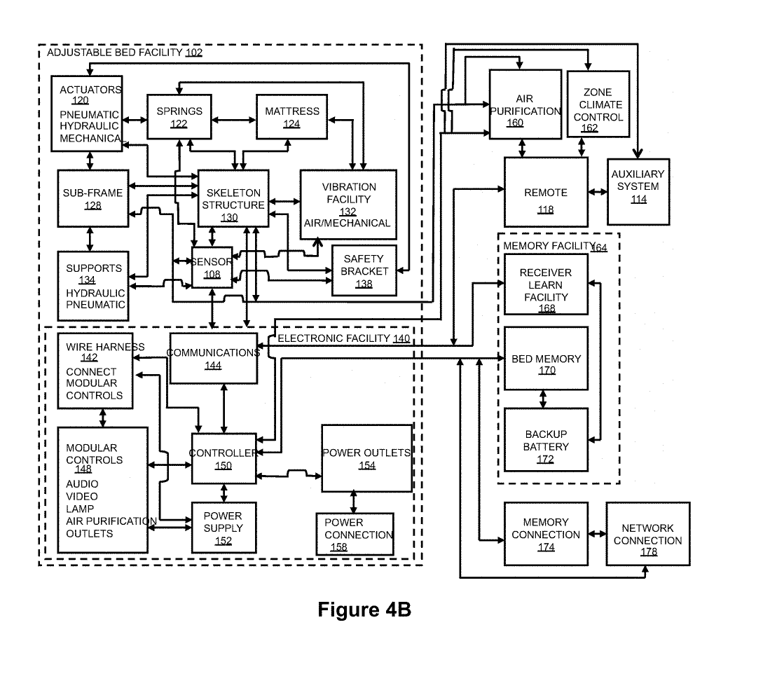

FIG. 4A illustrates a block diagram of the various components of an adjustable bed facility 102. In an embodiment, the adjustable bed facility 102 may be made up of a plurality of layers that may include a mechanical layer 104, a sensor layer 108, a control layer 110, and a network layer 112, and one or more auxiliary systems 114. In addition, the adjustable bed facility 102 may interact with a remote control 118 and the like. In an embodiment, the auxiliary systems 114 may include an entertainment system 114a, a kitchen appliance 114b, a vehicle control system 114c, a light control system 114d, a home control system 114e, and the like. In an embodiment, the auxiliary systems 114 may be combined with the adjustable bed facility 102, stand-alone devices, or the like.

In an embodiment, the mechanical layer 104 may include physical aspects of the adjustable bed facility 102 that provide support for the user. The mechanical layer 104 may include actuators, springs, mattresses, a sub-frame, a skeleton structure, vibration motors, supports, and safety brackets of the adjustable bed facility 102. These support and connection members may have any shape or configuration required to provide the support and connections needed by the various other components.

In an embodiment, the sensor layer 108 may include a plurality of sensors of various types. The sensor layer 108 may be interchangeably referred as sensor 108 within this disclosure. The sensors may be mechanical sensors, electrical sensors, bio-sensors, and so on. In embodiments, the sensor(s) may be associated with the various mechanical and electrical components that make up the mechanical layer 104. For example, the sensor(s) may be associated with an actuator to assess the position of the actuator or the mechanical pressure being exerted on the actuator or some other mechanical component. The sensor(s) may also be associated with an electrical component to assess the electrical component's condition. In other embodiments, the sensors may be associated with the mattress such that sleeping, resting, sitting, and other user conditions can be assessed. The information from the sensor lay may be fed back into a processor (e.g. within the electrical layer) for processing and response control. The response control may alter a condition of the adjustable bed, the mattress, an auxiliary system, or the like. The information from the sensor layer may also be processed and communicated to a remote control.

In an embodiment, the control layer 110 may coordinate the electronic requirements of the adjustable bed facility 102. The control layer 110 may interface with the sensor layer 108, the network layer 112, the remote control 118, the auxiliary systems 114, and the like. In an embodiment, the control layer 110 may receive control requests from a user for controlling the adjustable bed facility 102 functions by interfacing with the remote control 118. In an embodiment, the remote control 118 may communicate with the sensor layer 108 so that the latter may transmit the received requests to the control layer 110. In an embodiment, the control layer 110 may be combined with the adjustable bed facility 102, or it may be attached to the adjustable bed facility 102, or it may be a modular stand-alone device, or the like. In an embodiment, the control layer 110 and the sensor layer 108 may be individual devices or a combined device.

In an embodiment, the control layer 110 may also control functions of the adjustable bed facility 102 using a wired or wireless technology.

In an embodiment, the remote control 118 may be a user controlled device to provide control commands to the control layer 110 relating to certain functions of the adjustable bed facility 102. These functions may be adjustable bed facility section movement (e.g., up or down), vibration control, functions of modular devices, or the like. In an embodiment, the remote control 118 may communicate with the control box using wired communication, wireless communication, or the like.

Now referring to FIG. 4B, a block diagram of the various components of the adjustable bed facility 102 is shown. In an embodiment, an adjustable bed facility 102 may be made up of a number of devices and facilities that may include a sensor 108, actuators 120, springs 122, mattresses 124, a sub-frame 128, a skeleton structure 130, vibration motors 132, supports 134, safety brackets 138, an electronic facility 140, an air purification facility 160, a zone climate control system 162, a remote control 118, a memory facility 164, a memory connection 174, a network connection 178, and the like. In an embodiment, the electronic facility 140 may include a wire harness 142, communications module 144, modular controls 148, a controller 150, power outlets 154, a power connection 158, and the like. In an embodiment, the memory facility 164 may include a receiver learn facility 168, bed memory 170, a backup battery 172, and the like. In an embodiment, the receiver learn facility 168, bed memory 170, and backup battery 172 may not be part of the memory facility 164, but may be combined into other facilities or devices, be stand-alone devices, or the like.

In an embodiment, the physical aspects of the adjustable bed facility 102 that provide support for the user may include the actuators 120, springs 122, mattresses 124, a sub-frame 128, a skeleton structure 130, vibration motors 132, supports 134, and safety brackets 138.

In an embodiment, the skeleton structure 130 may provide the central structure that the other physical aspects may interact with. In an embodiment, the skeleton structure 130 may provide direct support to the mattress 124, springs 122, and the like. In an embodiment, the skeleton structure 130 may be a lightweight frame structure that may provide both the strength and rigidity required to properly support the mattress 124 and springs 122. In embodiments, the skeleton structure 130 may use materials that include metal, plastic, wood, or the like; the materials may be used individually or in combination.

In an embodiment, springs 122 may be used with a mattress 124, instead of a mattress 124, or the like. In an embodiment, the springs 122 may be a standard bed spring system (e.g. coils within a wire framework), individual coil springs, individual foam springs, air springs, or the like. In an embodiment, the individual springs (e.g. coil, foam, or air) may be used to provide variable firmness to provide comfort to the user. For example, the springs 122 may be less firm or firmer in a local area to provide the user with the support that may be required for a body location that is experiencing discomfort (e.g. a hip, shoulder, back, neck). Springs that may have local firmnesses will be described in more detail below.

In an embodiment, the mattress 124 may include foam, feathers, springs 122, material, or the like. In an embodiment, the different materials may be used individually or in combination. The mattress may be intended to provide the user with a firmness that provides for the comfort requirements of the user.

In an embodiment, the skeleton structure 130 may have structural members that support the mattress 124 and springs 122 and may also provide support and connections for the actuators 120, sub-frame 128, supports 134, vibrator motors 118, safety bracket 138, and the like. In an embodiment, the structural members may be positioned on the peripheral edges of the mattress 124 and springs 122 to provide overall support and rigidity to the mattress 124 and springs 122 and may form the base of the individual adjustable bed facility 102 sections. Additionally, there may other structural members as support, cross pieces, or the like that may provide additional support to the mattress 124 and springs 122 as may be required. A person knowledgeable in the art may understand that the frame structure may have many different construction configurations to provide support and rigidity to the mattress 124 and springs 122.

In an embodiment, the skeleton structure 130 may form the base of the adjustable bed facility 102 sections that may be moved relative to each other to provide the various bed positions required by the user. The adjustable bed facility 102 may include more than one section; a section may be fixed or may be adjustable. For example, the typical adjustable bed may have adjustable sections for the head, leg, and foot while the torso section may remain fixed and horizontal. There may be different combinations of movable and fixed sections with one or all of the sections being movable. In an embodiment, the sections may include the skeleton structure 130, mattress 124, springs 122, and the like, and may individually be small mattress structures of the entire adjustable bed facility 102 mattress.

In an embodiment, the adjustable bed sections may be connected together using hinges or like devices that allow a freedom of motion between two adjacent adjustable bed facility 102 sections. In an embodiment, one section of the adjustable bed may remain fixed, such as the torso section, and act as the foundation for the other movable sections to be positions. In an embodiment, any or none of the sections may be a fixed foundation section in the adjustable bed facility 102. In embodiments, there may be more than one adjustable bed facility 102 configuration depending on the requirements of a user, cost requirements, medical needs, or the like. For example, there may be a configuration where only the head section is adjustable to provide the user with the ability to have an elevated upper body position. This configuration may be a single purpose bed but may also provide the user with a less expensive adjustable bed facility 102 that meets the user's needs. One skilled in the art may understand that there may be many different adjustable bed facility configurations containing fixed and moveable sections.

This moveable section may also provide support and connection members for the components that may be used

In an embodiment, the skeleton structure 130, as part of each adjustable bed facility 102 section, may also provide support and connection members for the components that may be used to move the various adjustable bed facility 102 sections. There may be skeleton structure 130 members that provide connection support to the actuators 120, supports 134, safety brackets 138, vibration motors 132, and the like. These support and connection members may have any shape or configuration required to provide the support and connections needed by the various other components. For example, in addition to the skeleton structure 130 that is used to provide support to the mattress 124 and springs 122 there may be at least one cross member that may provide a connection to the actuator 120 and safety bracket 138.

In an embodiment, the skeleton structure 130 and the sub-frame 128 may interface with each other; the sub-frame 128 may provide structural support and a rigid foundation base to the skeleton structure 130. In an embodiment, the sub-frame 130 may be the rigid structure that is in contact to the floor and may provide a base for any fixed adjustable bed facility 102 sections and an interface for any movable adjustable bed facility 102 sections.

In an embodiment, the sub-frame 128 may have structural or support members that may run along the length of the adjustable bed facility 102 (e.g., longitudinal support members), run along the width of the adjustable bed facility 102 (e.g., lateral support members), run diagonally across the adjustable bed facility 102 (e.g., diagonal support members), or other orientation in relation to the adjustable bed facility 102 that may be required for support or connection to components.

In an embodiment, any adjustable sections may have two connections: a first connection provided by a hinge type connection and a second connection provided by the connection with the actuator 120 and safety bracket 138 that provide the force to rotate the adjustable bed facility 102 section up or down. In an embodiment, the hinge type connection between the skeleton structure 130 of a first section and a second section may provide the point of rotation for the section motion. In an embodiment, the adjustable bed facility 102 may contain more than one section and any or all of the sections may be connected by a hinge type connection.

With the adjustable bed facility 102 sections interconnected by using hinge type connections, there may be at least one actuator 120 that may provide a connection between a fixed adjustable bed facility 102 section and a moveable section. In an embodiment, the hinge connection between the adjustable bed facility 102 sections may be a pivot point bracket that may include additional strengthening to resist bending forces. In an embodiment, the actuation 120 connection may be between two of the skeleton structures 114. For example, a first end of the actuator 120 may be connected to the fixed torso section of the adjustable bed facility 102 and a second end of the actuator 120 may be connected to the section that is to be moved (e.g. head, leg, or foot sections). In an embodiment, the actuator 120 may use electric motors and mechanical gears, pneumatic pressure, hydraulic pressure, pneumatic spring, air spring, hydraulic spring or the like to provide the force to extend and retract the actuator 120. The action of extending and retracting the actuator 120 may move the various movable bed sections up or down. By the actuator 120 pushing against the section, the section may rotate upward around the pivot point provided by the hinge type connection. In the same manner, by the actuator 120 pulling against the section, the section may rotate downwards and around the pivot point provided by the hinge type connection. In an embodiment, there may be at least one actuator 120 for every moveable adjustable bed facility 102 section.

In an embodiment, there may be at least one vibration motor 132 that may provide vibration and massage functions to the adjustable bed facility sections and mattresses. In an embodiment, there may be vibration motors 132 associated with any of the adjustable bed facility sections. In an embodiment, there may be more than one vibration motor 132 for each adjustable bed facility section that may have vibration motors 132. In an embodiment, using a remote control, the user may be able to control the vibration mode of the various vibration motors 132; the mode may include the vibration setting for a particular bed section, the vibration frequency of at least one of the vibration motors, stopping the vibration of at least one of the vibration motors, or the like. The user may vary the vibration frequency for the particular bed section that has been positioned for a long duration. For example, the user may require different vibration frequencies for a body location that is experiencing discomfort (e.g. a hip, shoulder, back, neck). Such an arrangement may allow the user to vary the vibration frequency settings of various sections of the adjustable bed facility in case of inflexibility, pain or the like of any body portion.

In an embodiment, the vibration motor 132 may be an electric/mechanical device, a pneumatic device, a hydraulic device, or the like. The mechanical device may use an electric motor to rotate an offset mass to create a vibration; the vibration motor may be controlled for vibration frequency and amplitude by the speed of rotation of the electric motor. In an embodiment, a vibration motor 132 is mounted within an opening of an adjustable bed facility support lateral surface. The adjustable bed facility section may have a lateral surface and the lateral surface may include an opening in which the vibration motor 132 may be located; the vibration motor 132 may fit within the opening such that the vibration motor may not contact the lateral surface.

In an embodiment, the vibration motor 132 may be suspended from the adjustable bed facility section using at least one flexible connector 510 between the vibration motor 132 and at least one screw 512 wherein the one or more screws 512 are screwed into the board or lateral surface and there exists a gap between the screw head 514 and the lateral surface 102 sufficient to accommodate the connecting method 518, as shown in FIG. 3A. This gap may be in the range of 7-8 mm. Additionally, there may be a mechanical anchor to strengthen the support for the screw in the lateral surface. In other embodiments, various attachment means for attaching the flexible connector 510 to a bed frame support surface or other porting of the adjustable bed facility section can be used. Suitable attachment means include a hook element, a screw or bolt element, a flexible plastic tie element, a hook-and-loop fastening element, a bracket element, and combinations thereof. The flexible connector 510 may be made of a vibration-dampening, flexible, not ultra-rigid material such as rubber rope, and the like. The flexible connector 510 may be made from a somewhat resilient material although it should not be deformed by the weight of the vibration motor 132. The connecting method 518 may be a loop in the end of the flexible connector 510, as shown in FIG. 3B, a hook-like attachment at the end of the flexible connector 510, or the like. The flexible connector 510 may be permanently attached to the vibration motor 132. The flexible connector 510 may connect in removable fashion to the vibration motor 132 by such means as a loop or hook. The flexible connector 510 may pass through one or more openings in the vibration motor 132 as shown in FIG. 3C. The connection between the vibration motor 132 and the flexible connector may also comprise resilient material such as foam and the like. Foam may optionally be used to surround the vibration motor or may contact the motor on at least one surface.

In a further embodiment the vibration motor 132 may be covered with a housing 520 for purposes of aesthetics, shielding, noise reduction, and the like. The housing 520 may be designed to accommodate the one or more flexible connectors 510 and the one or more screws 512. FIG. 3D illustrates an example of such a housing 520 for the vibration motor 132 where the accommodation comprises a rib or raised area that aligns with the flexible connector 510 and screws 512. The housing 520 may comprise of one or more components. The housing 520 may have an opening for a power cord. The housing 520 may be made of plastic, metal, or the like and may be constructed using the materials individually or in combination.

In embodiments, a method for causing the bed massage or vibration motor 132 to be set according to a user selected setting may be provided. The method may include storing multiple values that may define a range of available settings for a bed massage or vibration motor, receiving a request to set the bed massage or vibration motor as the user selected setting, determining a value amongst the multiple values which may represent the user selected setting and causing the bed massage or vibration motor to be set to the user selected setting by using the value that represents the user selected setting. Storing of the multiple values may include storing a table having multiple entries. Each one of the multiple entries may specify one of the ranges of available settings for the bed massage motor. In embodiments, the user-selected setting may be an intensity setting, a mode setting, a frequency setting, or some other type of setting for the bed massage or vibration motor.

The massage or vibration motor 132 may provide vibration and massage functions to the adjustable bed. In an embodiment, there may be more than one massage or vibration motor in an adjustable bed facility 102. In this embodiment, using a remote control 118, the user may be able to control the vibration mode of the multiple massage or vibration motors; the mode may include the vibration setting for a particular bed section, the vibration frequency of at least one of the massage or vibration motors, stopping the vibration of at least one of the massage or vibration motors, or the like. In an embodiment, the multiple massage or vibration motors may be operated independently or in combination. In an embodiment, the vibration and massage functions may function as a gentle-wake alarm, being activated in response to an alarm clock signal, which may be generated by the electronic facility 140 (e.g., by an alarm clock running in the controller 150 or the like) or may be received as a signal from an external source (e.g., from the remote control 118 or the like), and so on.

In embodiments, users may use various types of mattresses 124 made from various materials with the adjustable bed facility 102. Various materials of mattresses may respond to vibration frequencies differently causing users to experience massage or vibrations of the mattress differently. For example, a particular frequency may vibrate a metal spring mattress and a latex foam rubber mattress differently. In embodiments, the bed controller 150 may adjust the frequency of the signal sent to the massage or vibration motor 132 and thereby adjust the motor's vibration frequency, which is translated to the mattress. Although the frequency of the command from the controller 150 to the massage or vibration motor may not equal the frequency of the vibration the motor transmits to the mattress, there may be a correlation. The user may adjust the frequency of the vibration via the remote control 118 or the bed controller 150 to create a vibration to suit the user's preference or for a particular purpose. In embodiments, buttons on the bed controller may allow for frequency adjustment. In embodiments, the controller may be preprogrammed with a table of frequencies suitable, or ideal for various types of mattresses or material combinations in the mattress. A user may be provided with a table showing the mattress types and the user may input the code that best corresponds to their mattress via the remote control 118 and/or controller 150. This may program the massage or vibration motor to operate at the frequency best suited or desired for a particular mattress or mattress material. In embodiments, the massage or vibration motor may be programmed for a particular mattress and may be adjusted based on other mattresses that are sold at retail. For example, natural rubber may vibrate best around 300 Hz. In embodiments, the controller is programmed with the resonant frequency for the mattress. In an embodiment, pulse width modulation (PWM) is used to modify the frequency of oscillation of the massage DC motor. In an embodiment, the massage motor may have a speed of 4000 rpm+/−10%, with the actual rpm varying over a range based on a level of massage requested by a user.

U.S. Publication No. 2016/0120740 is incorporated herein by reference in its entirety for disclosure related to the vibration motor assembly as well as other feature of an adjustable bed facility and a fixed bed facility for use with the vibration motor assembly.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the apparatus, compounds, compositions, methods, and processes are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A vibration motor assembly comprising:
a vibration motor;
at least one flexible connector adapted to suspend the vibration motor from a bed frame support surface;
a controller adapted to control the vibration motor; and
at least one of (i) an attachment means for attaching the flexible connector to the bed frame support surface and (ii) an attachment means for attaching the controller to the bed frame support surface or a corresponding bed facility.

2. The vibration motor assembly of claim 1, wherein the controller is adapted to control one or more of vibration frequency and vibration intensity of the vibration motor.

3. The vibration motor assembly of claim 1, wherein the controller is adapted to wirelessly receive a command from a remote control for control of the vibration motor.

4. The vibration motor assembly of claim 1, wherein the flexible connector is removably attachable to the vibration motor.

5. The vibration motor assembly of claim 4, wherein the vibration motor comprises at least one opening through which the flexible connector is adapted to pass to suspend the vibration motor.

6. The vibration motor assembly of claim 1, wherein the flexible connector is permanently attached to the vibration motor.

7. The vibration motor assembly of claim 1, wherein the flexible connector comprises a flexible rope.

8. The vibration motor assembly of claim 1, comprising at least two flexible connectors adapted to suspend the vibration motor.

9. The vibration motor assembly of claim 1, wherein the flexible connector is adapted to dampen vibration of the vibration motor.

10. The vibration motor assembly of claim 1, further comprising a housing adapted to mount to the bed frame support surface and at least partially enclose the vibration motor and the flexible connector.

11. The vibration motor assembly of claim 1, wherein the flexible connector comprises a loop connector adapted to attach the flexible connector to the bed frame support surface.

12. The vibration motor assembly of claim 1, wherein the flexible connector comprises a hook connector adapted to attach the flexible connector to the bed frame support surface.

13. The vibration motor assembly of claim 1, comprising the attachment means for attaching the flexible connector to the bed frame support surface.

14. The vibration motor assembly of claim 13, wherein the attachment means for attaching the flexible connector is selected from the group consisting of a hook element, a screw or bolt element, a flexible plastic tie element, a hook-and-loop fastening element, a bracket element, and combinations thereof.

15. The vibration motor assembly of claim 1, comprising the attachment means for attaching the controller to the bed frame support surface.

16. The vibration motor assembly of claim 15, wherein the attachment means for attaching the controller is selected from the group consisting of a hook element, a screw or bolt element, a flexible plastic tie element, a hook-and-loop fastening element, a bracket element, and combinations thereof.

17. The vibration motor assembly of claim 1, further comprising a remote control adapted to transmit a command to the controller for control of the vibration motor via a wired or wireless communication link to the controller.

18. A bed facility comprising:
a bed frame support surface; and
the vibration motor assembly of claim 1, wherein the vibration motor is suspended from the bed frame support surface by the at least one flexible connector, and the controller is associated with the bed frame support surface or other component of the bed facility.

19. The bed facility of claim 18, wherein:
the bed frame support surface comprises a plurality of lateral support elements and longitudinal support elements defining a plurality of openings; and
the at least one flexible connector is attached to at least one of the lateral support elements and the longitudinal support elements to suspend the vibration motor from the bed frame support.

20. The bed facility of claim 18, wherein:
the bed frame support surface is an adjustable bed frame comprising at least one articulating section; and
the bed facility further comprises an actuator associated with the adjustable bed frame and adapted to move the at least one articulating section.
